(19) United States
(12) Patent Application Publication
(10) Pub. No.: US 2016/0144808 A1
(43) Pub. Date: May 26, 2016

(54) WIRE HARNESS

(71) Applicant: YAZAKI CORPORATION, Tokyo (JP)

(72) Inventors: Nobuaki Date, Shizuoka (JP); Teruki Hamabayashi, Shizuoka (JP); Mitsunori Tsunoda, Shizuoka (JP)

(21) Appl. No.: 15/010,037

(22) Filed: Jan. 29, 2016

Related U.S. Application Data
(63) Continuation of application No. PCT/JP2014/069927, filed on Jul. 29, 2014.

(30) Foreign Application Priority Data
Aug. 1, 2013 (JP) 2013-160739

(51) Int. Cl. B60R 16/02

(52) U.S. Cl. CPC B60R 16/0215

(57) ABSTRACT

A wire harness including: a trunk line; a single-sided self-adhesive sheet which is bonded to itself across the trunk line to superimpose a pair of edge portions along the trunk line on each other so that the trunk line can be covered with the single-sided self-adhesive sheet; and a branch line which is made to diverge from the middle of the trunk line so as to be inclined to the trunk line, and which is sandwiched by and covered with the single-sided self-adhesive sheet and led out from between the pair of edge portions.

### CROSS REFERENCE TO RELATED APPLICATIONS

This application is a continuation of PCT application No. PCT/JP2014/069927, which was filed on Jul. 29, 2014 based on Japanese patent application No. 2013-160739 filed on Aug. 1, 2013, whose contents are incorporated herein by reference. Also, all the references cited herein are incorporated as a whole.

### BACKGROUND OF THE INVENTION

1. Technical Field

The present invention relates to a wire harness.

2. Background Art

There has been proposed a waterproof structure of a wire harness. For example, in the wire harness routed inside an engine room of a car, a divergence portion where a branch line diverges upward or obliquely upward from a trunk line may be located in a submergible region. In such a case, according to the waterproof structure, water invasion into the trunk line from the divergence portion can be prevented with a simple configuration (see JP-A-2003-143731).

As shown in FIG. 12, the waterproof structure of the wire harness is routed in the submergible region inside the engine room of the car. In a place where a branch line 503 diverges in a T-shape from a trunk line 501, the waterproof structure of the wire harness can prevent occurrence of water invasion into the trunk line from the T-shaped divergence position. A rectangular waterproof sheet 507 whose back surface is coated with an adhesive agent 505 is used. Opposite side portions 509 are wrapped around an outer circumferential surface of the trunk line 501 in a state in which a center portion of the waterproof sheet 507 is located on a lower surface of the trunk line in the T-shaped divergence position. Opposite side portions 511 extending from upper ends of the portions wrapped around the trunk line are bonded to each other across a base portion of the branch line 503 in a water sealing state. According to the waterproof structure of the wire harness, it is possible to surely attain waterproofness of the divergence portion of the wire harness in the submergible region inside the engine room.

### SUMMARY

However, in the aforementioned waterproof structure of the wire harness according to the background art, the branch line 503 diverges in the T-shape from the trunk line 501 and the diverging branch line 503 rises vertically to the trunk line 501. Therefore, a distance between a branch line divergence start position (a position where the branch line 503 is made to diverge from the trunk line 501) K and an outside branch line terminal position (a position where a terminal of an outside branch line 515 is located) M is shortest but the length of a covered branch line portion 513 covered with the waterproof sheet 507 cannot be secured sufficiently. Accordingly, fixing force of the waterproof sheet 507 cannot be applied to the covered branch line portion 513 sufficiently. As a result, when a large external force acts on the outside branch line 515 exposed from the waterproof sheet 507, there is a possibility that an edge portion leading-out position B which is the original divergence position of the branch line 503 may be deviated to thereby make the dimensions or direction of the branch line 503 unstable.

The invention has been accomplished in consideration of the aforementioned circumstances. An object of the invention is to provide a wire harness in which the dimensions or direction of a branch line can be made stable.

### Solution to Problem

The aforementioned object according to the invention can be achieved by the following configurations.

(1) A wire harness including: a trunk line; a single-sided adhesive sheet which is bonded to itself across the trunk line to superimpose a pair of edge portions along the trunk line on each other so that the trunk line is covered with the single-sided adhesive sheet; and a branch line which is made to diverge from the middle of the trunk line so as to be inclined to the trunk line, and which is sandwiched by and covered with the single-sided adhesive sheet and led out from between the pair of edge portions, wherein:

an angle formed between a covered branch line portion of the branch line and the trunk line is smaller than an angle formed between an outside branch line of the branch line and the pair of edge portions, the covered branch line portion being sandwiched by and covered with the single-sided adhesive sheet, the outside branch line being led out from between the pair of superimposed edge portions and exposed from the single-sided adhesive sheet.

According to the wire harness having the aforementioned configuration (1), the branch line made to diverge from a divergence portion of the trunk line is extended to be inclined to the trunk line. In the branch line thus extended to be inclined, a covered branch line portion is sandwiched by and covered with the single-sided adhesive sheet, and beyond the pair of edge portions of the single-sided adhesive sheet bonded to itself, the covered branch line portion turns to an outside branch line exposed from the single-sided adhesive sheet. The outside branch line is led out from between the pair of edge portions of the single-sided adhesive sheet. An edge portion leading-out position where the outside branch line is led out from between the pair of edge portions superimposed on each other is a predetermined branch line divergence position. That is, the covered branch line portion ranging from a branch line divergence start position (a position where the branch line is made to diverge from the trunk line) to the edge portion leading-out position is routed to be inclined to the trunk line. Therefore, a fixation length with which the branch line is sandwiched by and fixed to the single-sided adhesive sheet is longer than that in the background-art structure in which the branch line is made to diverge vertically from the trunk line. Thus, fixing force with which the single-sided adhesive sheet adheres to the covered branch line portion ranging from the branch line divergence start position to the edge portion leading-out position is larger than that in the background-art structure.

In addition, a fixation length of the covered branch line portion can be secured long when a distance between a position (branch line divergence start position) where the branch line is made to diverge from the trunk line and a position of a terminal of the outside branch line (a position where a terminal of the outside branch line is located) is the same.

(2) A wire harness having the aforementioned configuration (1), wherein: a covered branch line portion of the branch line made to diverge from the trunk line to be inclined at an acute angle to the trunk line has a U-turn shape folded portion which extends along the trunk line and more frontward than a branch line divergence start position.

According to the wire harness having the aforementioned configuration (2), when a worker retains the divergence portion with his/her finger in order to cover the trunk line and the covered branch line portion with the single-sided adhesive sheet, the U-turn shape folded portion of the covered branch line portion urges the trunk line adjacent thereto due to repulsive force by rigidity of electric wires so as to press the trunk line toward an opposite side to the edge portion leading-out position. Therefore, the electric wires of the trunk line inside the sheet can be suppressed from getting loose so that the trunk line and the covered branch line portion can be covered collectively. In addition, when the worker retains the divergence portion with his/her finger, the dimensional accuracy of the branch line divergence position increases in the covered branch line portion whose U-turn shape folded portion is supported. Accordingly, the workability for covering the divergence portion with the single-sided adhesive sheet is improved.

(3) A wire harness having the aforementioned configuration (1), wherein: the single-sided adhesive sheet which is bonded to itself to cover the trunk line and a covered branch line portion of the branch line is folded along a folding line parallel with the trunk line.

According to the wire harness having the aforementioned configuration (3), a folding angle of the single-sided adhesive sheet can be changed so that a leading-out angle (an angle to a tangential line along a circumferential direction of the trunk line) of the outside branch line which is made to diverge from the trunk line so as to be exposed from the single-sided adhesive sheet can be set desirably.

In addition, when the single-sided adhesive sheet which has been folded is fixed by an adhesive tape etc., fixing force with which the single-sided adhesive sheet adheres to the covered branch line portion increases so that the dimensional accuracy of the branch line divergence position and the dimensional accuracy of the edge portion leading-out position can be further increased.

According to the wire harness according to the invention, it is possible to make the dimensions or direction of the branch line stable.

The invention has been described above briefly. Further, when an undermentioned mode (which will be hereinafter referred to as “embodiment”) for carrying out the invention is read through with reference to the accompanying drawings, details of the invention can be made further clear.

### BRIEF DESCRIPTION OF THE DRAWINGS

FIG. 1 is a partially broken plan view and a main part enlarged view of a wire harness according to a first embodiment of the invention.

FIG. 2 is a partially broken plan view of a wire harness according to a second embodiment of the invention.

FIG. 3 is a plan view of a wire harness according to a third embodiment of the invention.

FIG. 4 is a plan view showing a wiring step for manufacturing the wire harness according to an embodiment of the invention.

FIG. 5 is an explanatory view explaining an effect of the wire harness shown in FIG. 1.

FIG. 6A is a plan view of a wire harness in which an angle of inclination of a covered branch line portion is smaller than an angle of inclination of an outside branch line, and FIG. 6B is a plan view of a wire harness in which an angle of inclination of a covered branch line portion is larger than an angle of inclination of an outside branch line.

FIG. 7 is a plan view showing a wiring step for manufacturing a wire harness according to a fourth embodiment of the invention.

FIG. 8 is a partially broken plan view showing a sheet wrapping step for manufacturing the wire harness shown in FIG. 7.

FIG. 9 is a sectional view seen from a direction of arrows IX-IX in FIG. 8.

FIG. 10A is a plan view showing a completed state of the wire harness shown in FIG. 7, and FIG. 10B is a sectional view seen from a direction of arrows X-X in FIG. 10A.

FIG. 11 is a sectional view showing a modification of the wire harness shown in FIGS. 10.

FIG. 12 is a perspective view showing a waterproof structure of a wire harness according to the background art.

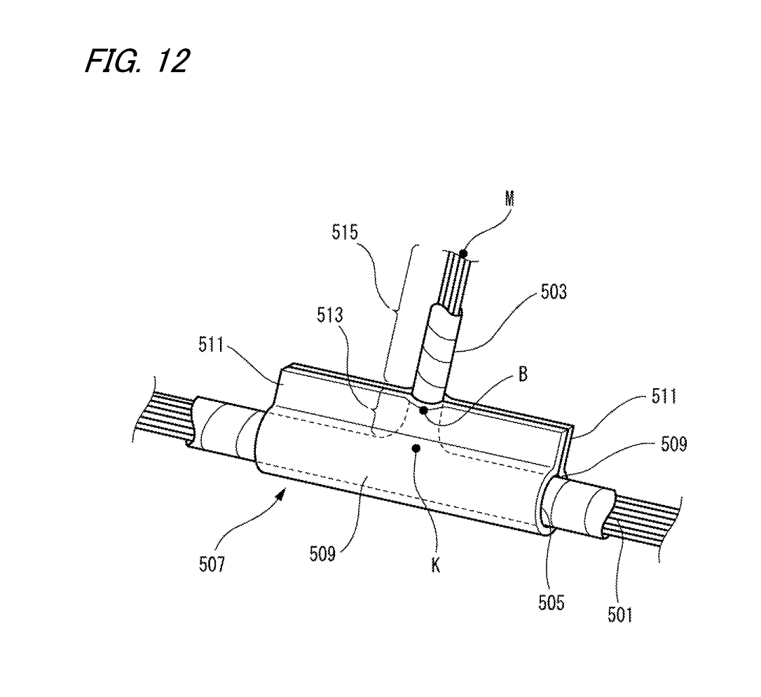

### DETAILED DESCRIPTION OF EMBODIMENTS

Embodiments according to the invention will be described below with reference to the drawings.

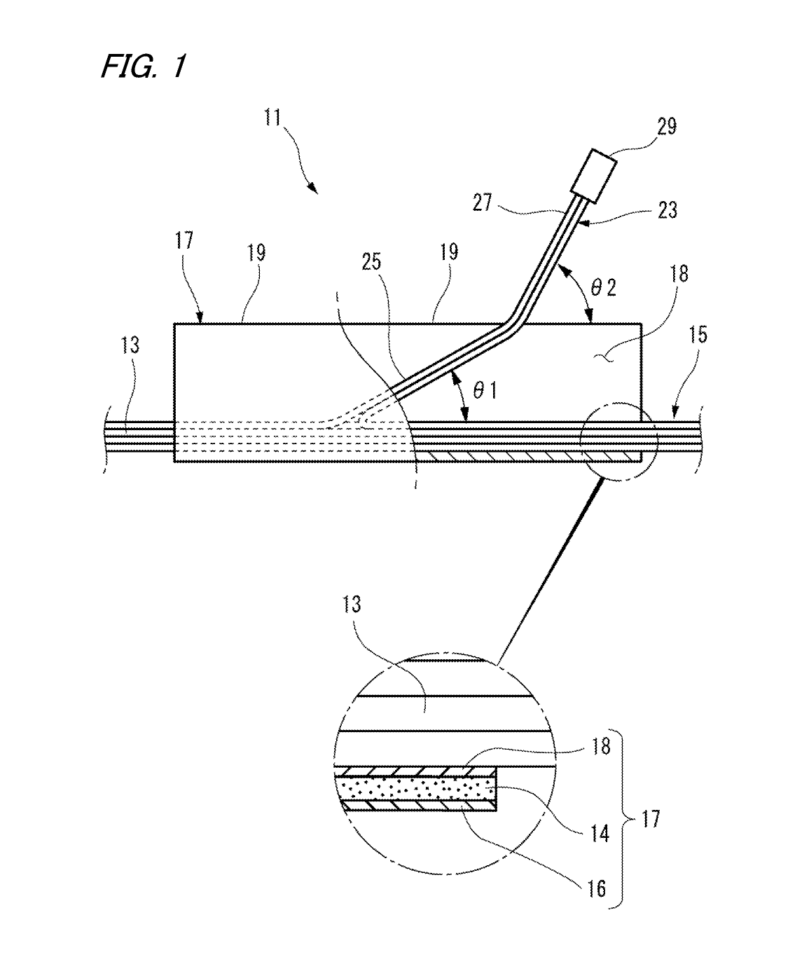

As shown in FIG. 1, a wire harness 11 according to a first embodiment of the invention has a trunk line 15 and a branch line 23. In the trunk line 15, a plurality of covered electric wires 13 are collected. The branch line 23 is made to diverge from the middle of the trunk line 15.

For example, the plurality of covered electric wires 13 may be bundled in the trunk line 15 by an adhesive tape (not shown) in a half-wrap winding manner. At least a linear portion of the trunk line 15 is covered with a single-sided self-adhesive sheet (single-sided adhesive sheet) 17.

As shown in an enlarged section in FIG. 1, the single-sided self-adhesive sheet 17 as a single-sided adhesive sheet used in the embodiment is a self-adhesive sheet which can be bonded to itself only when halves of its own adhesive surface (back surface) are made to face each other. That is, without requiring any paste or any binding band, the single-sided self-adhesive sheet 17 can be bonded to itself easily when the halves of the adhesive surface (back surface) are made to face each other. Further, a special adhesive agent layer 18 of the single-sided self-adhesive sheet 17 does not adhere to the wire harness 11, any finger of a worker, etc. Thus, there is no fear that the single-sided self-adhesive sheet 17 may lower the assembling workability. In the single-sided self-adhesive sheet 17, a surface material 16 is laminated on a front surface of a sheet substrate 14 made of a PP (polypropylene) foamed material, and the special adhesive agent layer 18 is laminated on a back surface of the sheet substrate 14. A sheet of kraft paper, a linerboard, a PET (polyethylenterephthalat) film, a PP film, a piece of non-woven fabric, etc. may be used for the surface material 16. The single-sided self-adhesive sheet 17 has characteristics such as tensile strength of 49 N/cm width in a longitudinal direction and 23 N/cm width in a lateral direction (based on JIS K-6767), tear strength of 7.8 N in the longitudinal direction and 6.8 N in the lateral direction (based on JIS K-6767), a moisture vapor transmission rate of 0.0052 g/cm²·24 hrs (FS-101B), and an initial adhesive force of 2.5 N/cm width (T-type peel test). For example, Cro-nel (registered trademark) etc. may be used as the single-sided self-adhesive sheet 17. Incidentally, the single-sided adhesive sheet according to the invention is not limited to the aforementioned single-sided self-adhesive sheet 17, but a self-adhesive sheet in which a special adhesive agent layer is laminated on one surface of a general sheet substrate which does not contain any foamed material, or a well-known adhesive sheet in which an adhesive agent is applied partially or wholly to at least one surface of a sheet substrate may be used alternatively.

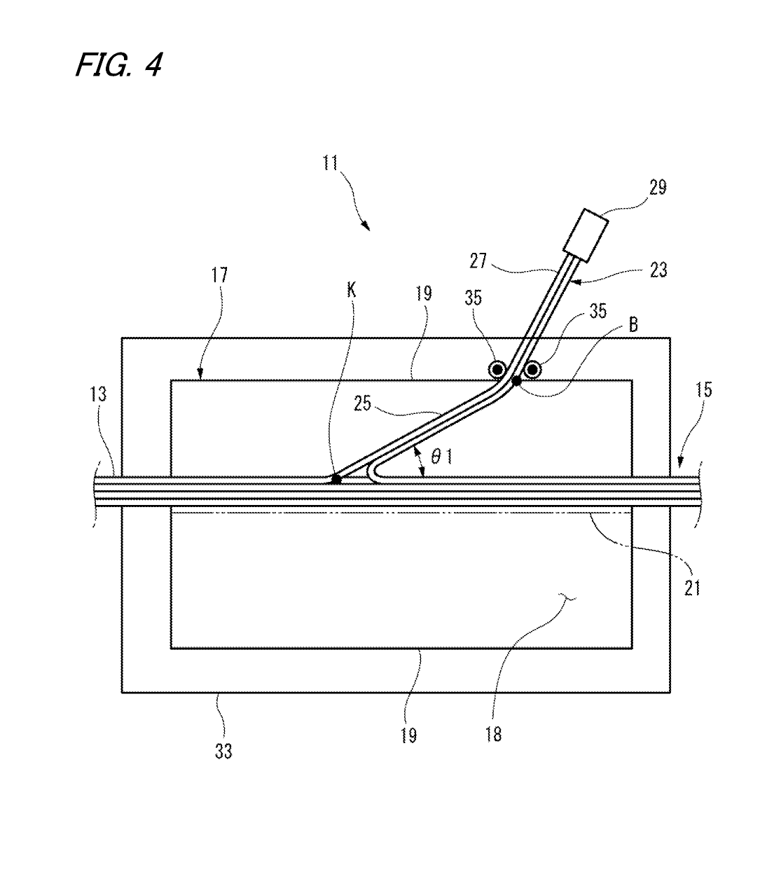

The trunk line 15 is sandwiched by and covered with the single-sided self-adhesive sheet 17. For example, the single-sided self-adhesive sheet 17 is formed into a quadrilateral shape along the linear portion of the trunk line 15, and has a pair of edge portions 19 along the trunk line 15 (see FIG. 4).

Before the trunk line 15 is sandwiched by and covered with the single-sided self-adhesive sheet 17, the trunk line 15 is placed on an upper half of the quadrilateral shape with the special adhesive agent layer 18 up, as shown in FIG. 4. Of the single-sided self-adhesive sheet 17 in which the trunk line 15 is placed on the upper half, a lower half is folded to an upper side with a folding line 21 of a central portion along the trunk line 15 as the boundary. Thus, the halves of the special adhesive agent layer 18 are fixed and bonded to each other so that the pair of edge portions 19 which are upper and lower sides of the single-sided self-adhesive sheet 17 can be superimposed on each other. That is, the single-sided self-adhesive sheet 17 is half as large as the unfolded quadrilateral shape in an up/down direction.

Although the embodiment will be described in the case where one single-sided self-adhesive sheet 17 is used by way of example, two single-sided adhesive sheets having the same shape may be used in the wire harness according to the invention. In this case, in the wire harness, the two single-sided adhesive sheets are bonded to each other across the trunk line 15. On this occasion, the two single-sided adhesive sheets are bonded to each other so that a pair of edge portions which correspond to one sides of the two single-sided adhesive sheets respectively can be superimposed on each other.

As shown in FIG. 1, the branch line 23 including a predetermined number of covered electric wires 13 is made to diverge from the middle of the linear portion of the trunk line 15. The branch line 23 is made to diverge from a divergence portion in the middle of the trunk line 15 to be inclined at a predetermined angle θ1 to the trunk line 15. The diverging branch line 23 is divided into a covered branch line portion 25 and an outside branch line 27. The covered branch line portion 25 is sandwiched by and covered with the single-sided self-adhesive sheet 17 which is bonded to itself. The outside branch line 27 is led out from between the pair of edge portions 19 and exposed from the single-sided self-adhesive sheet 17. That is, the branch line 23 led out from between the pair of edge portions 19 superimposed on each other is the outside branch line 27 which is inclined at a predetermined angle θ2 to the trunk line 15. For example, a connector 29 is attached to a terminal of the outside branch line 27.

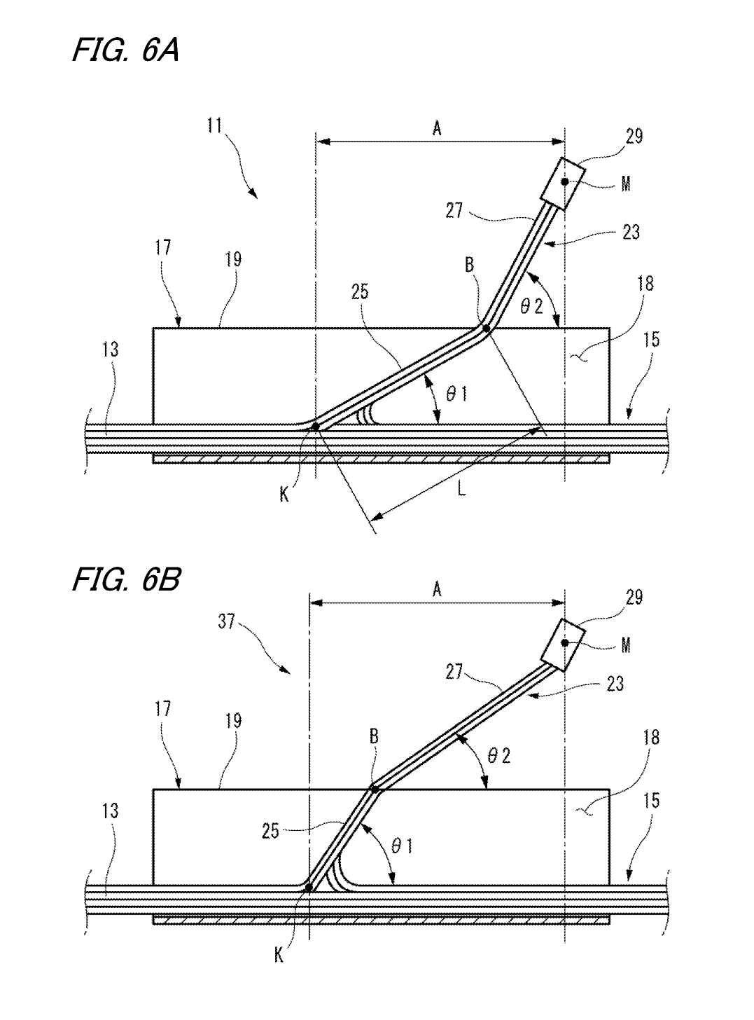

In the wire harness 11, it is preferable that the angle θ1 formed between the covered branch line portion 25 sandwich by and covered with the single-sided self-adhesive sheet 17 and the trunk line 15 is smaller than the angle θ2 formed between the outside branch line 27 led out from between the pair of edge portions 19 superimposed on each other and the pair of edge portions 19. Thus, when a distance A between a branch line divergence start position (a position where the branch line 23 is made to diverge from the trunk line 13) K and an outside branch line terminal position (a position where the terminal (connector 29) of the outside branch line 27 is located) M is the same (see FIGS. 6) as will be described later, a fixation length L of the covered branch line portion 25 can be secured long.

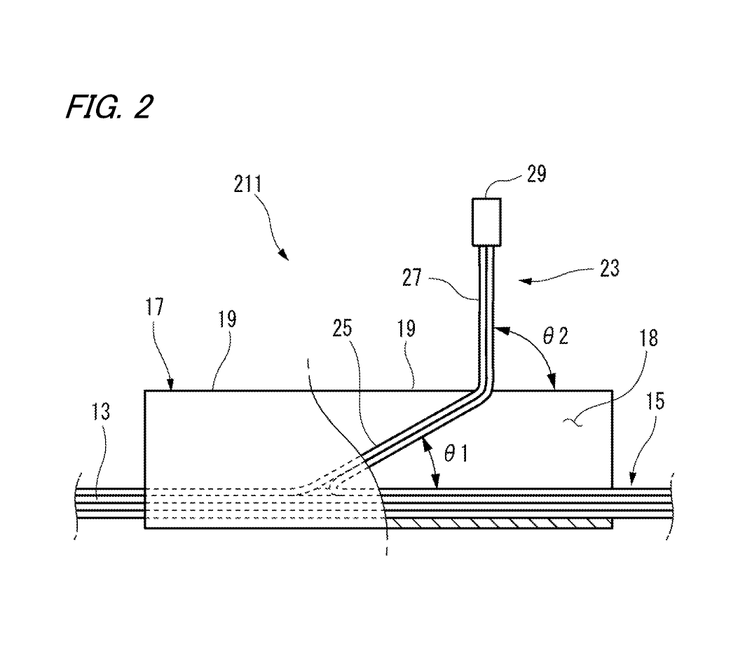

In addition, the angle θ2 formed between the outside branch line 27 led out from between the pair of edge portions 19 superimposed on each other and the pair of edge portions 19 may be a right angle (θ2=90°) as in a wire harness 211 according to a second embodiment of the invention shown in FIG. 2. Also in the case, the angle θ1 formed between the covered branch line portion 25 and the trunk line 15 is an angle smaller than 90° (θ1<90°). Thus, the covered branch line portion 25 is inclined to the trunk line 15. Incidentally, the term “inclined” means “inclined to be oblique”. In addition, the term “oblique” means neither vertical nor horizontal to a reference direction. The reference direction in the embodiment is an extension direction of the trunk line 15. That is, the covered branch line portion 25 extends neither vertically nor horizontally but to be inclined to the trunk line 15.

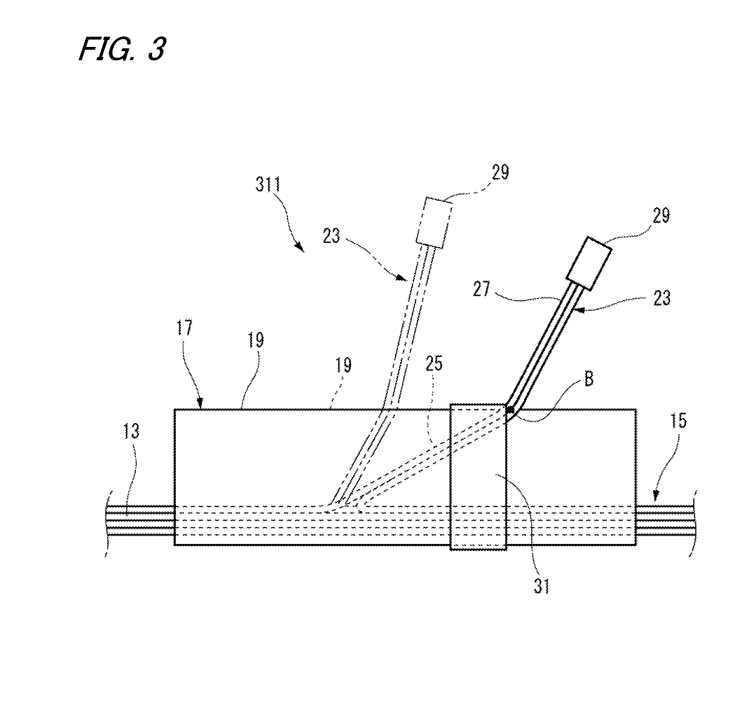

In addition, as in a wire harness 311 according to a third embodiment of the invention shown in FIG. 3, a reinforcement adhesive tape 31 may be wrapped around the single-sided self-adhesive sheet 17 on the covered branch line portion 25 side (the left side in FIG. 3) of the outside branch line 27 in an edge portion leading-out position B. Thus, it is possible to further increase fixing force with which the single-sided self-adhesive sheet 17 adheres to the branch line 23 in the edge portion leading-out position B. Such a configuration can be preferably used for the wire harness 311 in which the dimensions of the branch line 23 are required to be more highly accurate.

FIG. 4 is a plan view showing a wiring step for manufacturing the wire harness according to an embodiment of the invention.

The single-sided self-adhesive sheet 17 and a wiring drawing board 33 are used for manufacturing the wire harness 11. Working is performed on the wiring drawing board 33 where a plurality of covered electric wires 13 are placed. In the wiring drawing board 33, a pair of pins 35 are erected in an extension direction of the branch line 23. The pins 35 are erected separately from each other so that the branch line 23 can be put between the pins 35. The diverging branch line 23 is disposed between the pins 35. The trunk line 15 is disposed to keep the branch line divergence start position K in the extension direction of the trunk line 15 and at a distance from the pins 35. The upper side (which is the upper side in FIG. 4 as one edge portion 19 of the pair of edge portions 19) of the single-sided self-adhesive sheet 17 which has been unfolded is disposed adjacently to the pins 35. Since the branch line divergence start position K is at a predetermined distance from the pins 35, the position between the pins 35 is the edge portion leading-out position B. The branch line 23 diverging from the divergence portion of the trunk line 15 and put between the pins 35 is shaped into a straight line and disposed to be inclined at the angle θ1 to the trunk line 15.

In this state, the lower half of the single-sided self-adhesive sheet 17 is folded back to the upper side with the folding line 21 as the boundary and superimposed on the upper half of the single-sided self-adhesive sheet 17 so that the single-sided self-adhesive sheet 17 can be halved in the up/down direction. Incidentally, the lower side which is the lower side of the single-sided self-adhesive sheet 17 in FIG. 4 is the other edge portion 19 in the pair of edge portions 19. Thus, as shown in FIG. 1, the halves of the special adhesive agent layer 18 are fixed to each other so that the trunk line 15 and the branch line 23 can be covered with the single-side self-adhesive sheet 17 in a sandwiched state. Of the single-sided self-adhesive sheet 17, the upper and lower sides folded and superimposed on each other are the pair of edge portions 19. The pair of edge portions 19 are disposed in parallel with the trunk line 15. Of the branch line 23, the part which is led out from between the pair of edge portions 19 superimposed on each other is the outside branch line 27, and the part which is covered with the single-side self-adhesive sheet 17 is the covered branch line portion 25.

Next, an effect of the wire harness 11 having the aforementioned configuration will be described.

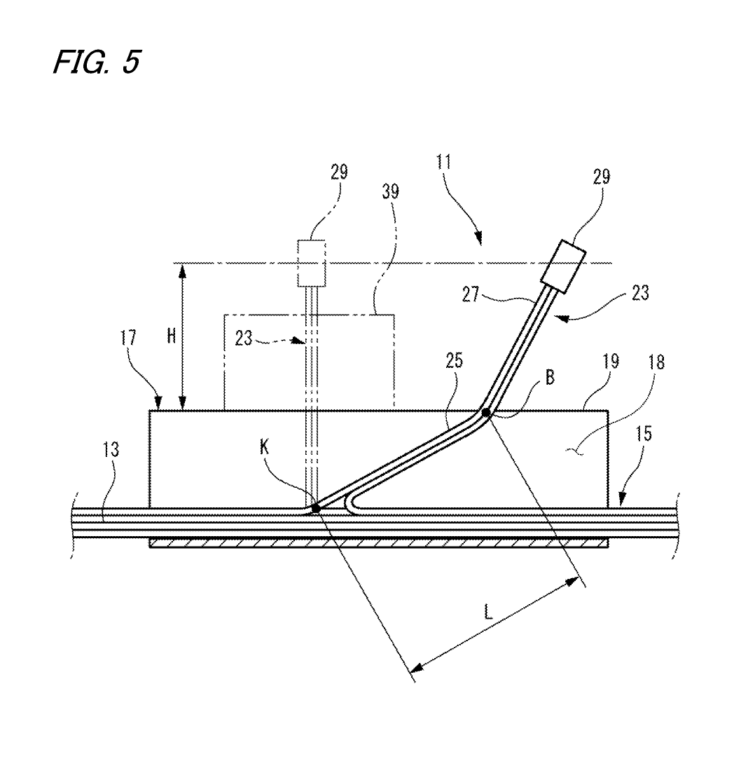

As shown in FIG. 5, according to the wire harness 11 according the first embodiment, the branch line 23 diverging from the divergence portion of the trunk line 15 extends to be inclined to the trunk line 15. In the branch line 23 thus extending to be inclined, the covered branch line portion 25 is sandwiched by and covered with the single-sided self-adhesive sheet 17, and beyond the pair of edge portions 19 of the single-sided self-adhesive sheet 17 bonded to itself, the covered branch line portion 25 turns to the outside branch line 27 exposed from the single-sided self-adhesive sheet 17. The outside branch line 27 is led out from between the pair of edge portions 19 of the single-sided self-adhesive sheet 17. That is, the outside branch line 27 is not covered with the single-sided self-adhesive sheet 17. The edge portion leading-out position B where the outside branch line 27 is led out from between the pair of edge portions 19 superimposed on each other is a predetermined branch line divergence position of the branch line 23.

That is, the covered branch line portion 25 ranging from the branch line divergence start position K to the edge portion leading-out position B is routed to be inclined to the trunk line 15. Therefore, the fixation length L with which the branch line 23 is sandwiched by and fixed to the single-sided self-adhesive sheet 17 is longer than that in a background-art structure (see an imaginary line in FIG. 5) in which the branch line 23 is made to diverge vertically from the trunk line 15. Thus, fixing force with which the single-sided self-adhesive sheet 17 adheres to the covered branch line portion 25 ranging from the branch line divergence start position K to the edge portion leading-out position B is larger than that in the background-art structure. Since the fixing force of the single-sided self-adhesive sheet 17 is increased, the edge portion leading-out position B of the branch line 23 cannot be deviated easily even when external force is applied to the branch line 23. As a result, in the wire harness 11, the outside branch line 27 can be formed with high accuracy.

Assume that the branch line 23 has the same extension length H from between the pair of edge portion 19 and the branch line 23 diverges vertically from the trunk line 15. In this case, in order to obtain the same fixation length L, convex portions 39 have to be provided in the pair of edge portions 19 respectively as indicated by the imaginary line in FIG. 5. Accordingly, a yield of the single-sided self-adhesive sheet 17 is lowered. According to the wire harness 11 in the embodiment, the yield of the single-sided self-adhesive sheet 17 can be improved and the fixing force with which the single-sided self-adhesive sheet 17 adheres to the covered branch line portion 25 can be increased with a smaller sheet area.

In addition, in the wire harness 11 according to the first embodiment, the angle θ1 formed between the covered branch line portion 25 sandwiched by and covered with the single-sided self-adhesive sheet 17 and the trunk line 15 is smaller than the angle θ2 formed between the outside branch line 27 led out from between the pair of edge portions 19 and exposed from the single-sided self-adhesive sheet 17 and the pair of edge portions 19, as shown in FIG. 6A. Thus, a fixation length L of the covered branch line portion 25 can be secured long.

For example, consider the cases where the distances A between the branch line divergence start positions K and the outside branch line terminal positions M are the same, as shown in FIGS. 6A and 6B. Then, the fixation length L of the covered branch line portion 25 in the wire harness 11 according to the first embodiment where θ1<θ2 as shown in FIG. 6A is secured to be longer than that in a wire harness 37 where θ1>θ2 as shown in FIG. 6B. Incidentally, in the cases of the configurations of FIGS. 6A and 6B, the edge portion leading-out positions B are different from each other. To make the edge portion leading-out position B of the wire harness 11 in FIG. 6A the same as that of the wire harness 37 in FIG. 6B, wiring may be performed so that the branch line divergence start position K and the edge portion leading-out position B can be shifted leftward in FIG. 6A so as to increase the length of the outside branch line 27. Thus, while the edge portion leading-out position B is made the same, the fixing force with which the single-sided self-adhesive sheet 17 adheres to the covered branch line portion 25 can be further increased.

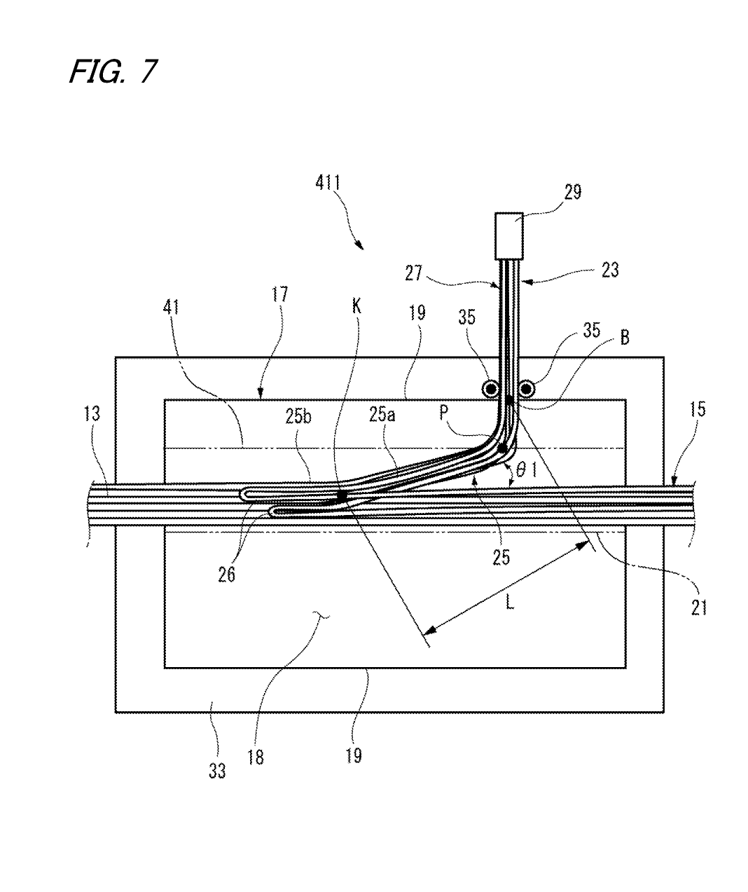

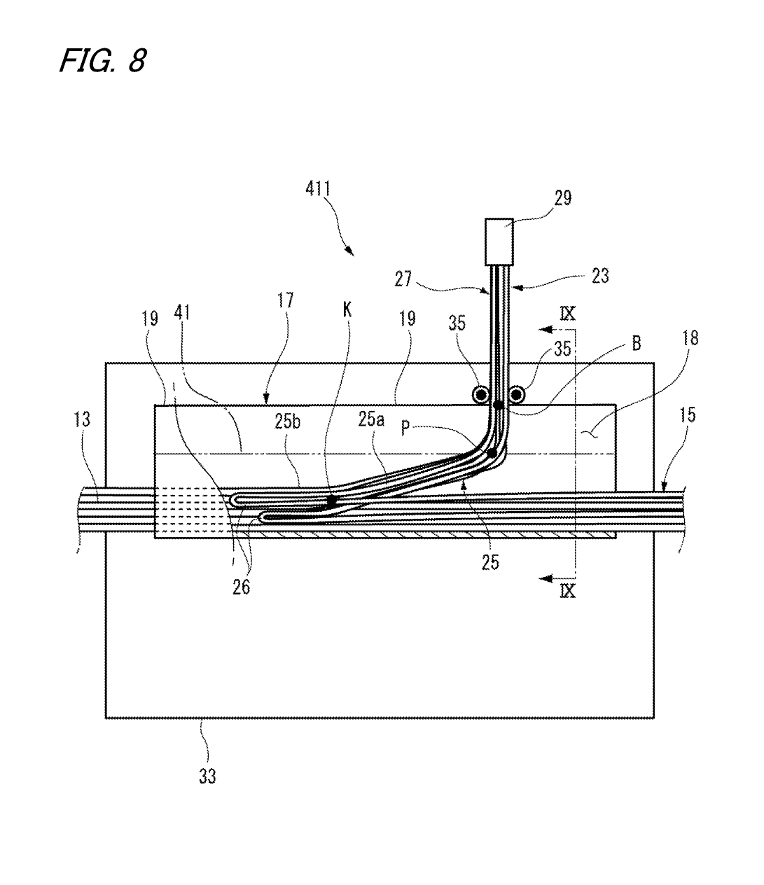

FIG. 7 and FIG. 8 are plan views showing steps for manufacturing a wire harness according to a fourth embodiment of the invention.

When a wire harness 411 according to the fourth embodiment is manufactured, a trunk line 15 is disposed to keep a branch line divergence start position K in an extension direction of the trunk line 15 and at a distance from pins 35. One edge portion 19 serving as an upper side of a single-sided self-adhesive sheet 17 which has been unfolded is disposed adjacently to the pins 35. Since the branch line divergence start position K of the trunk line 15 is at a predetermined distance from the pins 35, the position between the pins 35 is an edge portion leading-out position B. A branch line 23 diverging from the divergence portion of the trunk line 15 and put between the pins 35 is disposed to be inclined at an angle θ1 to the trunk line 15. The branch line 23 is formed into a shape bent at a branch line bending position P corresponding to a folding line 41 parallel with the trunk line 15 which will be described later.

Further, a covered branch line portion 25a (a covered branch line portion 25 which is routed from a right direction in FIG. 7 and then bent at an acute angle in the branch line divergence start position K) of the branch line 23 made to diverge from the trunk line 15 so as to be inclined at an acute angle to the trunk line 15 has a U-turn shape folded portion 26 which extends along the trunk line 15 and more frontward (leftward in FIG. 7) than the branch line divergence start position K.

As shown in FIG. 8, a lower half of the single-sided self-adhesive sheet 17 is folded back to an upper side with a folding line 21 as the boundary and superimposed on an upper half of the single-sided self-adhesive sheet 17 so that the single-sided self-adhesive sheet 17 can be halved in an up/down direction. The trunk line 15 and the covered branch line portion 25 are covered with the single-sided self-adhesive sheet 17 in a sandwiched state. On this condition, a covered branch line portion 25b routed from a left direction in FIG. 7 and then made to diverge is curled in a bent state at an obtuse angle in the branch line divergence start position K. On the other hand, the covered branch line portion 25a routed from the right direction in FIG. 7 and then made to diverge is curled in a bent state at an acute angle in the branch line divergence start position K. When a worker retains the divergence portion with his/her finger, the U-turn shape folded portion 26 urges the trunk line 15 adjacent thereto due to repulsive force by rigidity of electric wires so as to press the trunk line 15 toward an opposite side to the edge portion leading-out position B.

Therefore, in the wire harness 411, the electric wires of the trunk line 15 inside the sheet can be suppressed from getting loose so that the trunk line 15 and the covered branch line portion 25 can be covered collectively. In addition, when the worker retains the divergence portion with his/her finger, the dimensional accuracy of the branch line divergence position K increases in the covered branch line portion 25a whose U-turn shape folded portion 26 is supported. Accordingly, the workability for covering the divergence portion with the single-sided self-adhesive sheet 17 in the wire harness 411 according to the fourth embodiment is improved.

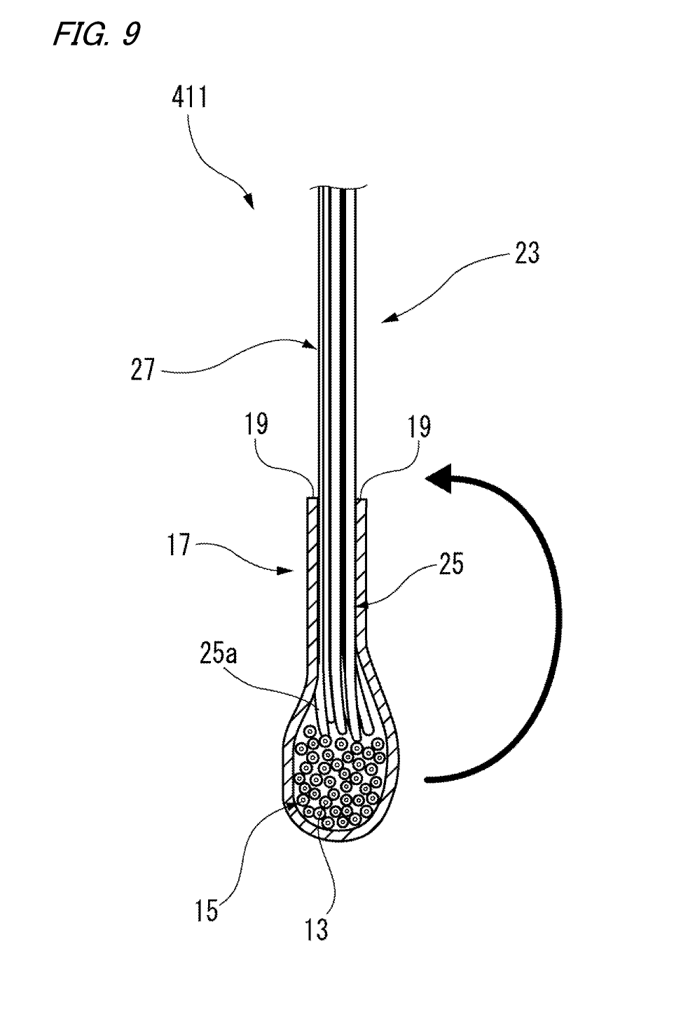

In the single-sided self-adhesive sheet 17 covering the trunk line 15 and the covered branch line portion 25, halves of a special adhesive agent layer 18 are fixed and bonded to each other so that the pair of edge portions 19 as the upper and lower sides of the single-sided self-adhesive sheet 17 can be superimposed on each other. As indicated by an arrow in FIG. 9, the single-sided self-adhesive sheet 17 on this occasion is folded (at a folding angle of 180°) so that a lower half of the single-sided self-adhesive sheet 17 can be folded back to the upper side along a folding line 41 (see FIG. 8) parallel with the trunk line 15.

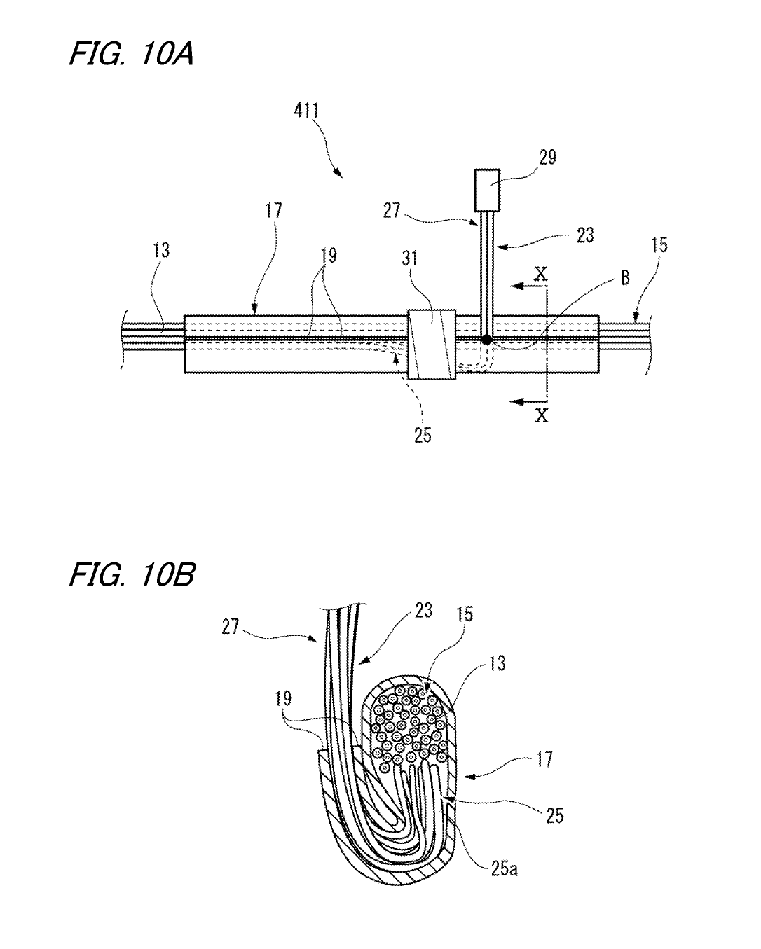

A fixation adhesive tape 31 is wrapped around the single-sided self-adhesive sheet 17 on the covered branch line portion 25 side (the left side in FIG. 10A) of an outside branch line 27 in the vicinity of the edge portion leading-out position B. That is, as shown in FIG. 10B, the single-sided self-adhesive sheet 17 with which the trunk line 15 and the covered branch line portion 25 are covered is fixed in the folded state by the adhesive tape 31. Thus, in the wire harness 411, fixing force to the covered branch line portion 25 can increase and the dimensional accuracy of the branch line divergence position K and the dimensional accuracy of the edge portion leading-out position B can be further increased.

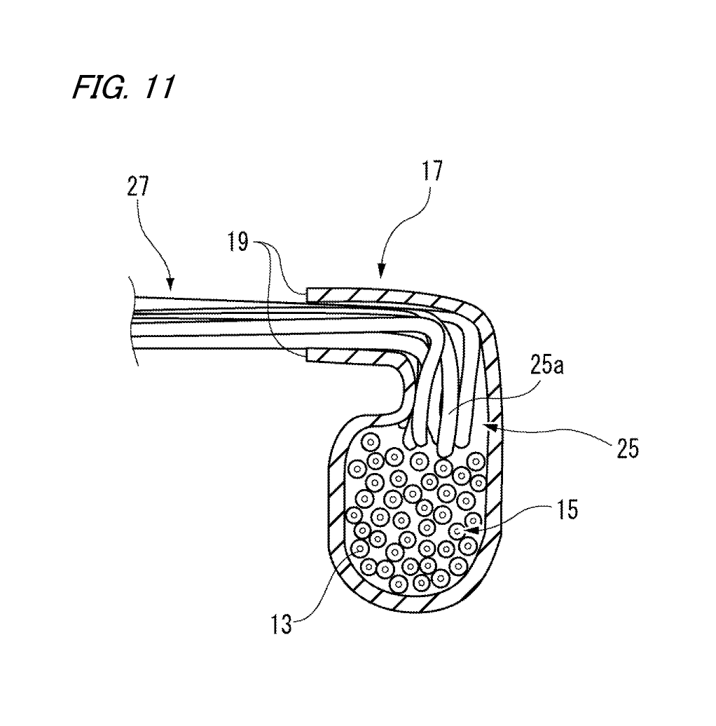

Incidentally, as shown in FIG. 10B, the single-sided self-adhesive sheet 17 with which the trunk line 15 and the covered branch line portion 25 are covered is folded, for example, at a folding angle of 90° along the folding line 41 (see FIG. 8) parallel with the trunk line 15. Thus, a leading-out angle of the outside branch line 27 made to diverge from the trunk line 15 and exposed from the single-sided self-adhesive sheet 17 (an angle to a tangential line (a tangential line extending in the up/down direction in FIG. 11) along a circumferential direction of the trunk line 15) can be also set at 90°.

That is, in the wire harness 411 according to the fourth embodiment, the leading-out angle of the outside branch line 27 made to diverge from the trunk line 15 and exposed from the single-sided self-adhesive sheet 17 can be set desirably in accordance with the shape of a mounting portion of a vehicle body panel. Accordingly, the workability for arranging the wire harness 411 into the vehicle body panel is improved.

Accordingly, according to each of the wire harnesses 11, 211, 311 and 411 according to the embodiments, the dimensions or direction of the branch line 23 can be made stable.

Here, the aforementioned characteristics of the embodiments of the wire harness according to the invention will be summarized and listed as follows.

[1] A wire harness (11) including:

a trunk line (15);

a single-sided adhesive sheet (single-sided self-adhesive sheet 17) which is bonded to itself across the trunk line (15) to superimpose a pair of edge portions (19) along the trunk line (15) on each other so that the trunk line (15) is covered with the single-sided adhesive sheet (single-sided self-adhesive sheet (17)); and

a branch line (23) which is made to diverge from the middle of the trunk line (15) so as to be inclined to the trunk line (15), and which is sandwiched by and covered with the single-sided adhesive sheet (single-sided self-adhesive sheet (17)) and led out from the pair of edge portions (19), wherein:

an angle (θ1) formed between a covered branch line portion (25) of the branch line (23) and the trunk line (15) is smaller than an angle (θ2) formed between an outside branch line (27) of the branch line (23) and the pair of edge portions (19), the covered branch line portion (25) being sandwiched by and covered with the single-sided adhesive sheet (single-sided self-adhesive sheet (17)), the outside branch line (27) being led out from between the pair of superimposed edge portions (19) and exposed from the single-sided adhesive sheet (single-sided self-adhesive sheet (17)).

[2] A wire harness (411) according to the aforementioned configuration [1], wherein:

a covered branch line portion (25) of the branch line (23) made to diverge from the trunk line (15) to be inclined at an acute angle to the trunk line (15) has a U-turn shape folded portion (26) which extends along the trunk line (15) and more frontward than a branch line divergence start position (K).

[3] A wire harness (411) according to the aforementioned configuration [1], wherein:

the single-sided adhesive sheet (single-sided self-adhesive sheet (17) which is bonded to itself to cover the trunk line (15) and a covered branch line portion (25) of the branch line (23) is folded along a folding line (41) parallel with the trunk line (15).

Incidentally, the invention is not limited to the aforementioned embodiments. Any modification, improvement, etc. can be made on the invention suitably. In addition thereto, the materials, the shapes, the dimensions, the numbers, the arrangement places, etc. of the constituent members in the aforementioned embodiments are not limited but may be set desirably as long as the invention can be achieved.

According to the wire harness according to the invention, it is possible to provide a wire harness in which the dimensions or direction of a branch line can be made stable.

What is claimed is:

1. A wire harness comprising:
a trunk line;
a single-sided adhesive sheet which is bonded to itself across the trunk line to superimpose a pair of edge portions along the trunk line on each other so that the trunk line is covered with the single-sided adhesive sheet; and
a branch line which is made to diverge from the middle of the trunk line so as to be inclined to the trunk line, and which is sandwiched by and covered with the single-sided adhesive sheet and led out from between the pair of edge portions, wherein:
an angle formed between a covered branch line portion of the branch line and the trunk line is smaller than an angle formed between an outside branch line of the branch line and the pair of edge portions, the covered branch line portion being sandwiched by and covered with the single-sided adhesive sheet, the outside branch line being led out from between the pair of edge portions and exposed from the single-sided adhesive sheet.

2. A wire harness according to claim 1, wherein: a covered branch line portion of the branch line made to diverge from the trunk line to be inclined at an acute angle to the trunk line has a U-turn shape folded portion which extends along the trunk line and more frontward than a branch line divergence start position.

3. A wire harness according to claim 1, wherein: the single-sided adhesive sheet which is bonded to itself to cover the trunk line and a covered branch line portion of the branch line is folded along a folding line parallel with the trunk line.
